(19) United States
(12) Patent Application Publication
(10) Pub. No.: US 2017/0134928 A1
(43) Pub. Date: May 11, 2017

(54) MOBILITY SUPPORT FOR WLAN DEVICES

(71) Applicant: QUALCOMM Incorporated, San Diego, CA (US)

(72) Inventors: Alecsander Petru EITAN, Haifa (IL); Amichai SANDEROVICH, Atlit (IL); Gal BASSON, Haifa (IL)

(21) Appl. No.: 15/344,572

(22) Filed: Nov. 6, 2016

Related U.S. Application Data
(60) Provisional application No. 62/252,407, filed on Nov. 6, 2015.

(51) Int. Cl. H04W 8/02; H04L 25/02

(52) U.S. Cl. CPC H04W 8/02; H04L 25/0202; H04W 84/12

(57) ABSTRACT

Certain aspects of the present disclosure generally relate to mobility support for wireless local area network (WLAN) devices, such as 60 GHz millimeter wave (e.g. IEEE 802.11ay) devices. An exemplary method includes obtaining an indication of a coherence time associated with a wireless node, generating a frame having additional Channel Estimation Fields, which can occur periodically in the frame, based at least in part on the indicated coherence time, or having Scattered Pilots in Orthogonal Frequency Division Multiplexing (OFDM) symbols, and outputting the frame for transmission to the wireless node.

### CLAIM OF PRIORITY UNDER 35 U.S.C. §119

The present application for patent claims benefit of U.S. Provisional Patent Application Ser. No. 62/252,407, filed Nov. 6, 2015, assigned to the assignee hereof and hereby expressly incorporated by reference herein.

### BACKGROUND

Field of the Disclosure

Certain aspects of the present disclosure generally relate to wireless communications and, more particularly, to mobility support for wireless local area network (WLAN) devices, such as 60 GHz millimeter wave (e.g., IEEE 802.11ay) devices.

Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

Generally, a wireless multiple-access communication system can simultaneously support communication for multiple stations (STAs). Each STA communicates with one or more base stations via transmissions on the forward and reverse links. The forward link (or downlink) refers to the communication link from the base stations to the STAs, and the reverse link (or uplink) refers to the communication link from the STAs to the base stations. This communication link may be established via a single-input single-output, multiple-input single-output or a multiple-input multiple-output (MIMO) system.

In order to address the issue of increasing bandwidth requirements demanded for wireless communications systems, different schemes are being developed to allow multiple STAs to communicate with a single access point by sharing the channel resources while achieving high data throughputs. Multiple-input multiple-output (MIMO) technology represents one such approach that has recently emerged as a popular technique for next generation communication systems. MIMO technology has been adopted in several emerging wireless communications standards, such as the Institute of Electrical and Electronics Engineers (IEEE) 802.11 standard. The IEEE 802.11 standard denotes a set of Wireless Local Area Network (WLAN) air interface standards developed by the IEEE 802.11 committee for short-range communications (e.g., tens of meters to a few hundred meters).

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure generally relate to mobility support for wireless local area network (WLAN) devices, such as 60 GHz millimeter wave (e.g., IEEE 802.11ay) devices.

Certain aspects of the present disclosure provide an apparatus for wireless communications. The apparatus generally includes a first interface configured to obtain an indication of a coherence time associated with a wireless node, a processing system configured to generate a first frame having a length being limited based at least in part on the indicated coherence time, and a second interface configured to output the first frame for transmission to the wireless node.

Certain aspects of the present disclosure provide an apparatus for wireless communications. The apparatus generally includes a first interface configured to obtain an indication of a coherence time associated with a wireless node, a processing system configured to generate a frame, wherein the processing system is configured to generate at least a portion of the frame according to at least one orthogonal frequency division multiplexed (OFDM) symbol format with scattered pilot signals distributed across subcarriers if the indicated coherence time is less than or equal to a threshold value, and a second interface configured to output the frame for transmission to the wireless node.

Certain aspects of the present disclosure provide an apparatus for wireless communications. The apparatus generally includes a processing system configured to generate a first frame providing an indication of a coherence time associated with the apparatus, a first interface configured to output the first frame for transmission to a wireless node, and a second interface configured to obtain, from the wireless node, a second frame, wherein the processing system is configured to process the second frame based at least in part on the coherence time indicated in the first frame.

Certain aspects of the present disclosure also provide various other apparatuses, methods, and computer program products capable of performing (or causing an apparatus to perform) the operations described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents. Certain aspects also provide various methods, apparatuses, and computer program products capable of performing operations corresponding to those described above.

### BRIEF DESCRIPTION OF THE DRAWINGS

FIG. 1 illustrates a diagram of an example wireless communications network, in accordance with certain aspects of the present disclosure.

FIG. 2 illustrates a block diagram of an example access point (AP) and stations (STAs), in accordance with certain aspects of the present disclosure.

FIG. 3 illustrates a block diagram of an example wireless node, in accordance with certain aspects of the present disclosure.

FIGS. 4-4B illustrate example frame formats, in accordance with certain aspects of the present disclosure.

FIG. 5 sets forth example operations for wireless communications, in accordance with certain aspects of the present disclosure.

FIG. 5A illustrates example means capable of performing the operations set forth in FIG. 5.

FIGS. 6-6I illustrate example frame formats having additional channel estimation fields (CEFs), in accordance with certain aspects of the present disclosure.

FIGS. 7-7C illustrate example frame formats having periodic CEFs, in accordance with certain aspects of the present disclosure.

FIG. 8 sets forth example operations for wireless communications, in accordance with certain aspects of the present disclosure.

FIG. 8A illustrates example means capable of performing the operations set forth in FIG. 8.

FIG. 9 sets forth example operations for wireless communications, in accordance with certain aspects of the present disclosure.

FIG. 9A illustrates example means capable of performing the operations set forth in FIG. 9.

FIG. 10 is an example plot of time frequency resources illustrating scattered pilots, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Certain aspects of the present disclosure generally relate to mobility support for wireless local area network (WLAN) devices, such as 60 GHz millimeter wave (e.g., IEEE 802.11ay) devices. An access point (AP) may obtain an indication of a coherence time associated with a station (STA). The AP can generate a frame (e.g. a physical layer convergence protocol (PLCP) protocol data unit (PPDU)) having a length being limited based at least in part on the indicated coherence time. In certain aspects, the AP can generate at least a portion of the frame according to at least one orthogonal frequency division multiplexed (OFDM) symbol format with scattered pilot signals distributed across subcarriers if the indicated coherence time is less than or equal to a threshold value.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple STAs. A TDMA system may allow multiple STAs to share the same frequency channel by dividing the transmission signal into different time slots, each time slot being assigned to different STA. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an STA.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

### An Example Wireless Communication System

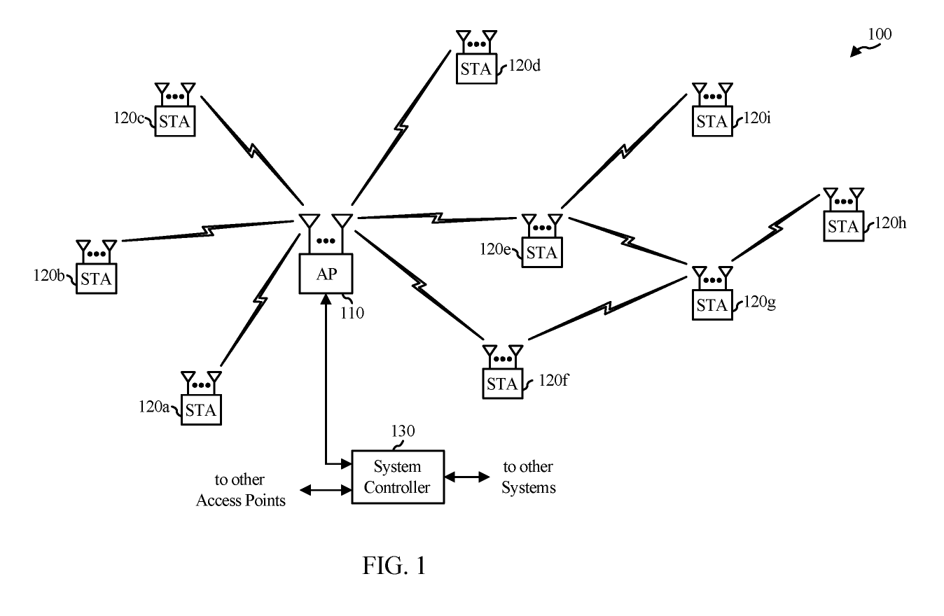

FIG. 1 illustrates a multiple-access multiple-input multiple-output (MIMO) system 100 with access points and STAs in which aspects of the present disclosure may be practiced. The MIMO system 100 may be a multiuser MIMO system (MU-MIMO). Although not illustrated in FIG. 1, another example wireless communication can be a single-input single-output (SISO) in which aspects of the present disclosure can be practiced. For example, one or more access points 110 may be configured to obtain an indication of a coherence time associated with a wireless node (e.g., from STA 120). The AP 110 can generate a frame (e.g., a PPDU) having a length being limited based at least in part on the indicated coherence time.

For simplicity, only one access point 110 is shown in FIG. 1. An access point is generally a fixed station that communicates with the STAs and may also be referred to as a base station or some other terminology. A STA may be fixed or mobile and may also be referred to as a mobile station, a wireless device or some other terminology. Access point 110 may communicate with one or more STAs 120 at any given moment on the downlink and uplink. The downlink (i.e., forward link) is the communication link from the access point to the STAs, and the uplink (i.e., reverse link) is the communication link from the STAs to the access point. A STA may also communicate peer-to-peer with another STA. A system controller 130 may couple to and provide coordination and control for the access point.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe STAs 120 capable of communicating via Spatial Division Multiple Access (SDMA), for certain aspects, the STAs 120 may also include some STAs that do not support SDMA. Thus, for such aspects, an access point (AP) 110 may be configured to communicate with both SDMA and non-SDMA STAs. This approach may conveniently allow multiple versions of STAs (“legacy” stations) to remain deployed in an enterprise, extending their useful lifetime, while allowing newer SDMA STAs to be introduced as deemed appropriate.

In the example MIMO system 100, the access point 110 and STAs 120 can employ multiple transmit and multiple receive antennas for data transmission on the downlink and uplink. In a SISO system, the AP 110 and STAs 120 can employ only a single antenna for transmission and reception. Although not shown, other example wireless communications systems in which the aspects of the present disclosure can be deployed include a SISO system, MU-MIMO system, single carrier MIMO system, or single carrier MU-MIMO system. For downlink MIMO transmissions, Nₐₚ antennas of the access point 110 represent the multiple-input (MI) portion of MIMO, while a set of K STAs represent the multiple-output (MO) portion of MIMO. Conversely, for uplink MIMO transmissions, the set of K STAs represent the MI portion, while the Nₐₚ antennas of the access point 110 represent the MO portion. For pure SDMA, it is desired to have Nₐₚ≧K≧1 if the data symbol streams for the K STAs are not multiplexed in code, frequency or time by some means. K may be greater than Nₐₚ if the data symbol streams can be multiplexed using TDMA technique, different code channels with CDMA, disjoint sets of subbands with OFDM, and so on. Each selected STA transmits user-specific data to and/or receives user-specific data from the access point. In general, each selected STA may be equipped with one or multiple antennas (i.e., Nᵤₜ≧1). The K selected STA can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each STA may be equipped with a single antenna (e.g., in order to keep costs down) or multiple antennas (e.g., where the additional cost can be supported). The system 100 may also be a TDMA system if the STAs 120 share the same frequency channel by dividing transmission/reception into different time slots, each time slot being assigned to different STA 120.

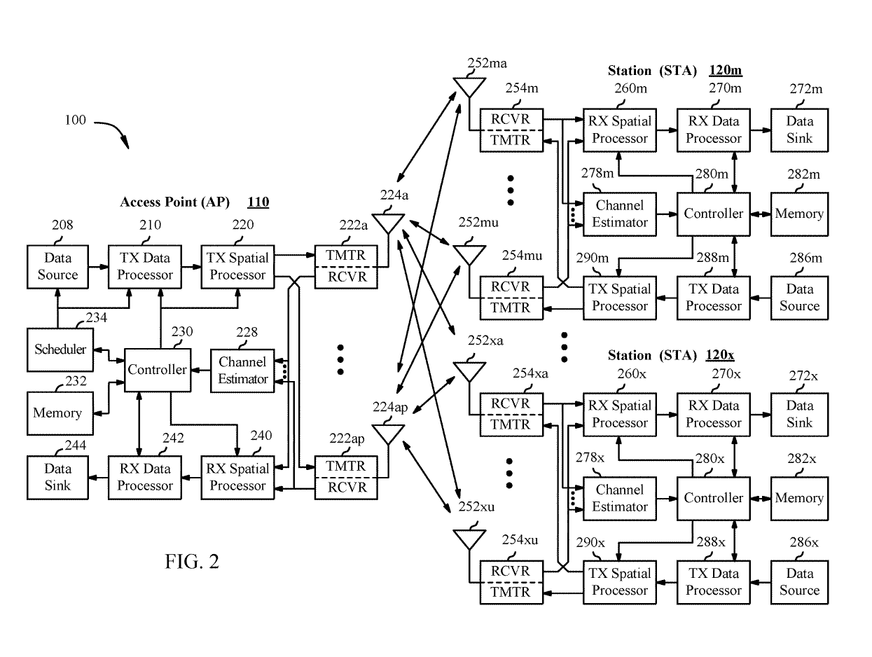

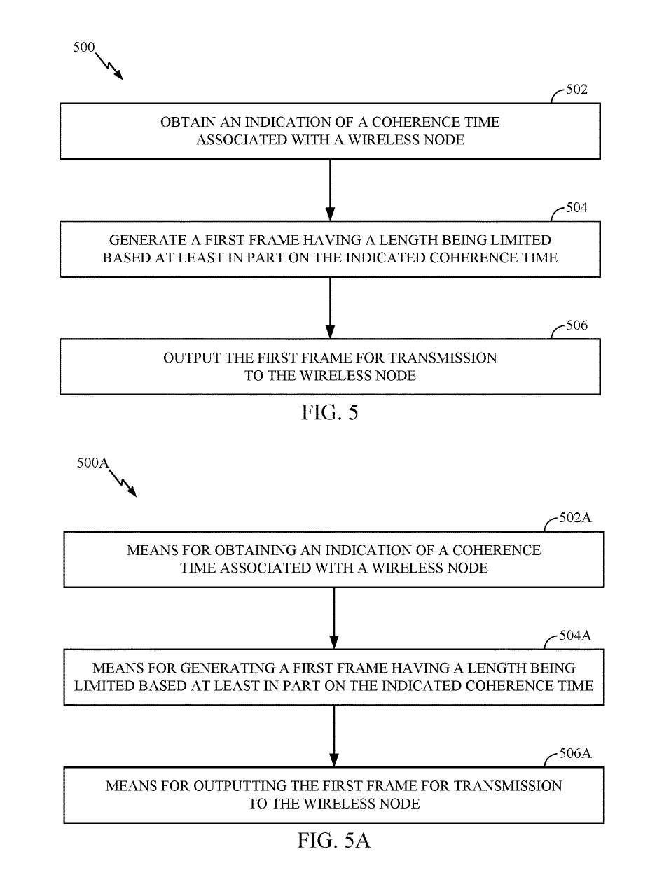

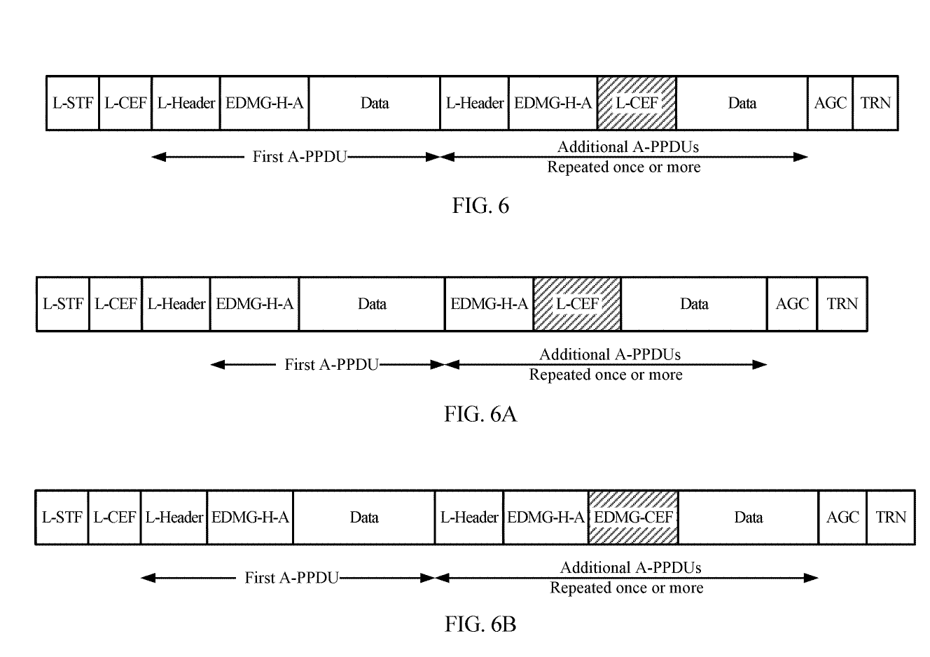

FIG. 2 illustrates a block diagram of access point 110 and two STAs 120m and 120x in MIMO system 100 that may be examples of the access point 110 and STAs 120 described above with reference to FIG. 1 and capable of performing the techniques described herein. The various processors shown in FIG. 2 may be configured to perform (or direct a device to perform) various methods described herein, for example, the operations 500, 800, and 900 described in association with FIGS. 5, 8, and 9.

FIG. 2 illustrates a block diagram of access point 110 and two STAs 120m and 120x in MIMO system 100. The access point 110 is equipped with Nₜ antennas 224a through 224ap. STA 120m is equipped with N_{ut,m} antennas 252ma through 252mu, and STA 120x is equipped with N_{ut,x} antennas 252xa through 252xu. The access point 110 is a transmitting entity for the downlink and a receiving entity for the uplink. Each STA 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink. For SDMA transmissions, Nᵤₚ STAs simultaneously transmit on the uplink, while N_{dn} STAs simultaneously transmit on the downlink. Nᵤₚ may or may not be equal to N_{dn}, and Nᵤₚ and N_{dn} may be static values or can change for each scheduling interval. The beam-steering or some other spatial processing technique may be used at the access point and STA.

On the uplink, at each STA 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the STA based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ STAs may be scheduled for simultaneous transmission on the uplink. Each of these STAs performs spatial processing on its data symbol stream and transmits its set of transmit symbol streams on the uplink to the access point.

At access point 110, Nₐₚ antennas 224a through 224ap receive the uplink signals from all Nᵤₚ STAs transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each STA may be provided to a data sink 244 for storage and/or a controller 230 for further processing. The controller 230 may be coupled with a memory 232.

On the downlink, at access point 110, a TX data processor 210 receives traffic data from a data source 208 for N_{dn} STAs scheduled for downlink transmission, control data from a controller 230, and possibly other data from a scheduler 234. The various types of data may be sent on different transport channels. TX data processor 210 processes (e.g., encodes, interleaves, and modulates) the traffic data for each STA based on the rate selected for that STA. TX data processor 210 provides N_{dn} downlink data symbol streams for the N_{dn} STAs. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the STAs.

At each STA 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the STA. The receiver spatial processing is performed in accordance with the CCMI, MMSE or some other technique. An RX data processor 270 processes (e.g., demodulates, deinterleaves and decodes) the recovered downlink data symbol stream to obtain decoded data for the STA. The decoded data for each STA may be provided to a data sink 272 for storage and/or a controller 280 for further processing.

At each STA 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each STA typically derives the spatial filter matrix for the STA based on the downlink channel response matrix H_{dn,m} for that STA. Controller 230 derives the spatial filter matrix for the access point based on the effective uplink channel response matrix H_{up,eff}. Controller 280 for each STA may send feedback information (e.g., the downlink and/or uplink eigenvectors, eigenvalues, SNR estimates, and so on) to the access point. Controllers 230 and 280 also control the operation of various processing units at access point 110 and STA 120, respectively.

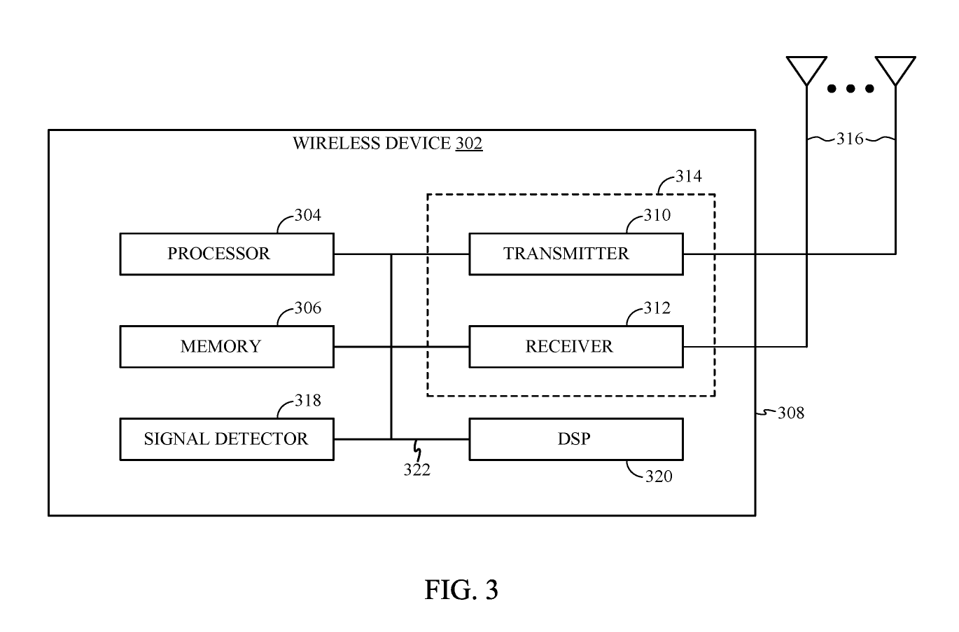

FIG. 3 illustrates example components that may be utilized in AP 110 and/or STA 120 to implement aspects of the present disclosure. For example, the transceiver 310, antenna(s) 316, processor 304, and/or DSP 320 may be used to practice aspects of the present disclosure implemented by an AP or STA, such as operations 500, operations 800, and/or operations 900 described in association with FIGS. 5, 8, and 9, respectively, below. The wireless device (e.g., wireless node) 302 may be an access point 110 or a STA 120.

The wireless node (e.g., wireless device) 302 may include a processor 304 which controls operation of the wireless node 302. The processor 304 may also be referred to as a central processing unit (CPU). The processor 304 may control the wireless node 302 in executing the various methods described herein, for example, the operations 500, 800, and 900 described in association with FIGS. 5, 8, and 9. Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein, for example, the operations 500, 800, and/or operations 900 described in association with FIGS. 5, 8, and 9, respectively, below.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers. The transceiver can use a single antenna (as shown) for both transmitting and receiving or can use different antennas (not shown) for transmitting and receiving.

The wireless node 302 may use multiple transmitters, multiple receivers, and/or multiple transceivers in communicating with a WWAN and one or more WLANs. Additionally or alternatively, the wireless node 302 may communicate with a WWAN via a single transceiver 314 and retune the transceiver 314 (tune away from the WWAN) to communicate with one or more WLANs.

The wireless node 302 may use multiple transmitters, multiple receivers, and/or multiple transceivers in communicating with a WWAN and one or more WLANs. Additionally or alternatively, the wireless node 302 may communicate with a WWAN via a single transceiver 310 and retune the transceiver 310 (tune away from the WWAN) to communicate with one or more WLANs.

The wireless node 302 may also include a signal detector 318 that may be used in an effort to detect and quantify the level of signals received by the transceiver 310. The signal detector 318 may detect such signals as total energy, energy per subcarrier per symbol, power spectral density and other signals. The wireless node 302 may also include a digital signal processor (DSP) 320 for use in processing signals.

The various components of the wireless node 302 may be coupled together by a bus system 322, which may include a power bus, a control signal bus, and a status signal bus in addition to a data bus.

In general, an AP and STA may perform similar (e.g., symmetric or complementary) operations. Therefore, for many of the techniques described herein, an AP or STA may perform similar operations. To that end, the following description will sometimes refer to an “AP/STA” to reflect that an operation may be performed by either. Although, it should be understood that even if only “AP” or “STA” is used, it does not mean a corresponding operation or mechanism is limited to that type of device.

### Example Mobility Support for WLAN Devices

Certain systems (e.g., systems operating according to the IEEE 802.11ad or IEEE 802.11ay wireless networking standards) have been designed to operate in particular frequency bands (e.g., 60 GHz). Some of these systems are designed with primary consideration of stationary transceivers (e.g., in a wireless device such as an access point (AP) or station (STA)).

However, some of these systems (e.g., 802.11ay systems) are designed with more consideration of mobile transceivers, such as a STA carried by a user. The user may be walking, moving or rotating the user's arm while holding the device, or riding in a moving vehicle with the device.

Device mobility generally refers to any displacement of the device, orientation change of the device, and environment changes of the device. Displacement mobility includes movement, for example in any or all of the X, Y, Z coordinate-planes, of the device in time.

As a few quantitative examples of displacement scenarios for a wireless device, a handheld device can move around 2 m/s due to hand movement of a user carrying the device, up to around 120 Km/h for devices in moving vehicles (such as automobiles), or up to around 400 Km/h for devices in moving trains. Orientation type change mobility can include rotation of handheld device that can occur when the device is held in a user's hand. Orientation can up to around 120 degrees in any direction in a single movement, which can take less than 1 sec (e.g., around 0.5 sec).

Device mobility can impact various procedures, such as channel impulse response (CIR), Doppler, STA beamforming, AP beamforming, and interference management. Displacement (Δx) can change the CIR between the AP and the STA. In order prevent CIR from changing, the following equation may need to be satisfied:

Δx≦λ/10,

where λ is 60 GHz wavelength (i.e., 5 mm). Thus, Δx should be less than 0.5 mm. For a device held by a pedestrian user (moving at 2 m/s), the time to pass the displacement distance is 250 μsec, for a device in a vehicle (moving at 33.33 m/sec), the time to pass the displacement distance is 15 μsec, and for a device in a train (moving at 111 m/sec), the time to pass the displacement distance is 4.5 μsec. Therefore, CIR is expected not to change with pedestrian movement for periods less than 250 μsec, vehicular movement for period less than 15 μsec, or train movement for periods less than 4.5 μsec. The same may be true for multiple input multiple output (MIMO) and channel bonding.

Displacement can also change the received frequency and cause timing drift, according to the Doppler Frequency which may be given the following equation:

$${f}_{D} = \frac{v}{c} \cdot {f}_{c}$$

where f_{D} is the Doppler frequency, ν is the velocity at which the mobile device is being displaced, c is the speed of light (3×10⁸), and f_{c} is carrier frequency (e.g., 60×10⁹). Thus, the Doppler Frequency for a device held by a moving pedestrian is 400 Hz, for a device in a moving vehicle is 6.6 KHz, and for a device in a moving train is 22 KHz. Orthogonal frequency division multiplexing (OFDM) subcarrier spacing is 5.15 MHz and, therefore, this may not an issue for Doppler Frequency 22 KHz or for Doppler shift lower than the LO accuracy of 20 ppm=1.2 MHz.

Orientation changes can also affect STA beamforming. For example, handheld devices can be rotated quite fast by user hand movement. Such orientation change may require STA sector changes or changes in beam selection. Mobile rotation speed can be up to 240 deg/sec with a maximum span of 120 deg. The minimum beam width of any STA beam is at least 60 deg. Thus, beamforming, by sector selection or beam refinement process (BRP), should be rechecked at least every 125 msec.

AP beamforming can be affected by handheld displacement. The handheld rotation can also impact the beamforming, but typically by less. The AP may have sectors as narrow as 2 deg. Pedestrian displacement may be up to 2 m/sec. Hence, at a radius of 2 m from the AP, the sector selection or BRP should be rechecked at least every 17.5 msec, where:

Perimeter=2*π*r (radius);

Mobile rotation time=2*π*r/ν

Time of half beam=2*π*r*(bandwidth/2)/(ν*360)

Certain systems, such as IEEE 802.11ay systems, may be designed with a focus on accounting for such high mobility of wireless devices. Accordingly, various techniques for supporting mobility of wireless devices may be particularly desirable in such systems.

Aspects of present disclosure provide techniques for supporting high mobility of wireless devices. Such techniques may include limiting physical layer convergence protocol (PLCP) protocol data unit (PPDU) length in time, using aggregated PPDUs (A-PPDUs) including channel estimation fields in each A-PPDU, inserting periodic channel estimation fields in a frame, and/or having data OFDM format include scattered pilots.

The aspects described herein may be implemented as separate alternatives or any combination of the options can be implemented. Any of the aspects presented herein can be used for any OFDM version. Many of the options may be used with single carrier operations. Aspects described herein may be applicable to systems supporting channel bonding, single user MIMO, and/or multi-user MIMO.

### Example Frame Formats

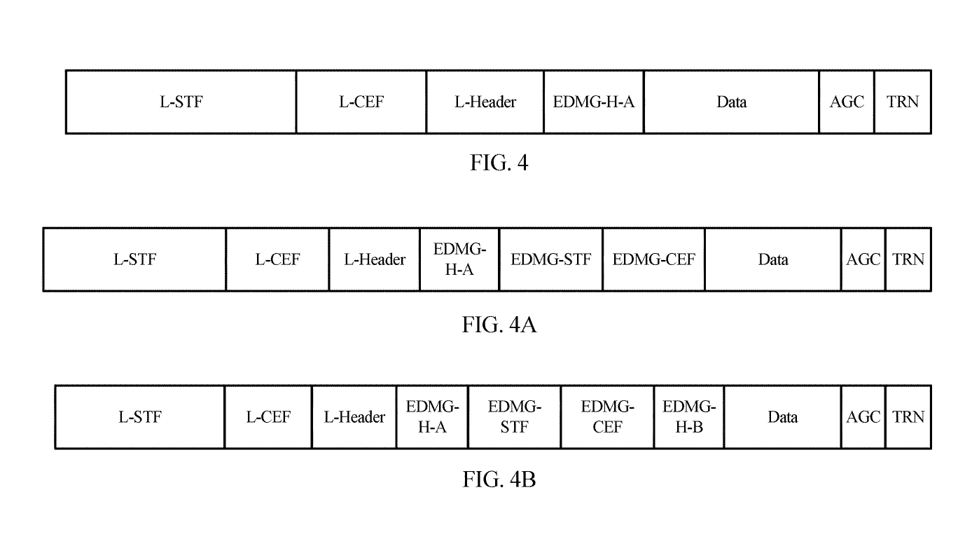

FIGS. 4-4B illustrate example frame formats, in accordance with certain aspects of the present disclosure. The techniques described herein may be performed using these example frame formats or using a different format.

As shown in FIG. 4, the frame format may include a legacy (e.g., as defined in the IEEE 802.11ad wireless standard) short training field (L-STF), a legacy channel estimation field (L-CEF), legacy header (L-Header), a new EDMG Header A (EDMG-H-A), a data portion carrying payload symbols (in some cases the data portion can be omitted), an automatic gain control (AGC) field for beamforming, and a TRN field that is a training field for beamforming. Beamforming can include section sweep, BRP, or other types of beamforming.

As shown in FIG. 4A, in another implementation, the example frame format may include the fields of the example frame format illustrated in FIG. 4, and can further include an EDMG-STF and an EDMG-CEF after the EDMG-H-A.

As shown in FIG. 4B, in yet another implementation, the example frame format can include the fields of the example frame format illustrated in FIG. 4B, and can further include an EDMG Header B (EDMG-H-B). The EDMG-H-B may be an optional field for MU-MIMO.

### Example Limiting of PPDU Length in Time

Certain aspects of the present disclosure may help support mobility by limiting PPDU length, in time. As such, the effects on changes in mobility may be limited within that time.

FIG. 5 sets forth example operations 500 for wireless communications, in accordance with certain aspects of the present disclosure. The operations 500 may be performed by a wireless node, for example, a station (e.g., AP 110 or STA 120).

Operations 500 may begin at 502, by obtaining an indication of a coherence time associated with a wireless node. At 504, the AP generates a first frame (e.g., PPDU or A-PPDU) having a length being limited based at least in part on the indicated coherence time. At 506, the AP outputs the first frame for transmission to the wireless node.

According to certain aspects, a new capability element can be added to each device that indicates the coherence time that the device is currently experiencing. The capability element can be sent, from time to time, via control messages to the other wireless node (e.g., an associated AP). A wireless node that receives the capability element can also sense the coherence time that the wireless node is currently experiencing and act accordingly (e.g., limiting transmission length of its own PPDUs).

According to certain aspects, the wireless node can compute a maximum PPDU size based on existing limitations (amount of data available to be sent, its buffers and other side buffers) and according to the coherence time (new parameter). The wireless node can use the lesser of the value it senses and the value received (from the other side) in the capability element when preparing PPDUs for transmission. For example, the wireless node computes a length of the PPDU based on the coherence time. The wireless node can use a PPDU Aggregation mechanism to increase link utilization, for example, when data to be transmitted is larger than the computed PPDU length. In some cases, the PPDU length may also be limited by the buffer size of the wireless node and the other wireless node.

According to certain aspects, a coherence time value can be converted to PPDU length according to the time it takes to send the PPDU at the actual rate that is being used. The conversion to an actual rate may be based on modulation coding scheme (MCS), channel bonding, and/or MIMO value).

In the case of an AP-STA connection, the coherence time may be mainly sent from the STA to the AP. In the case of STA-STA connection, each STA may send the coherence time to the other STA.

### Example Additional CEF in Each A-PPDU

According to certain aspects, in the case of A-PPDUs, mobility may be supported by including one or more additional CEFs in each A-PPDU.

A wireless node's support for such an A-PPDU may be indicated in a capability element for the wireless node. In some cases, a wireless node may only transmit A-PPDUs (with additional CEFs) to another wireless node that supports A-PPDU as a capability. An A-PPDU generally refers to a sequence of two or more PPDUs transmitted without typical inter-frame spacing (IFS), preamble, and separation between PPDU transmissions. A PPDU within an A-PPDU may contain an A-MPDU having a plurality of MPDUs. Each PPDU in an A-PPDU frame may be preceded only the Header except for the first PPDU and, in some cases, each A-PPDU may have a different length.

According to certain aspects, an additional CEF may be added before each Header in the A-PPDU for mobility support. The additional CEFs may be the same as the one that is used at the start of the frame or may be different. An additional bit in a Header (e.g., the EDMG-Header-A) can be used to inform the receiver that the additional CEF is added before each A-PPDU Header in the frame.

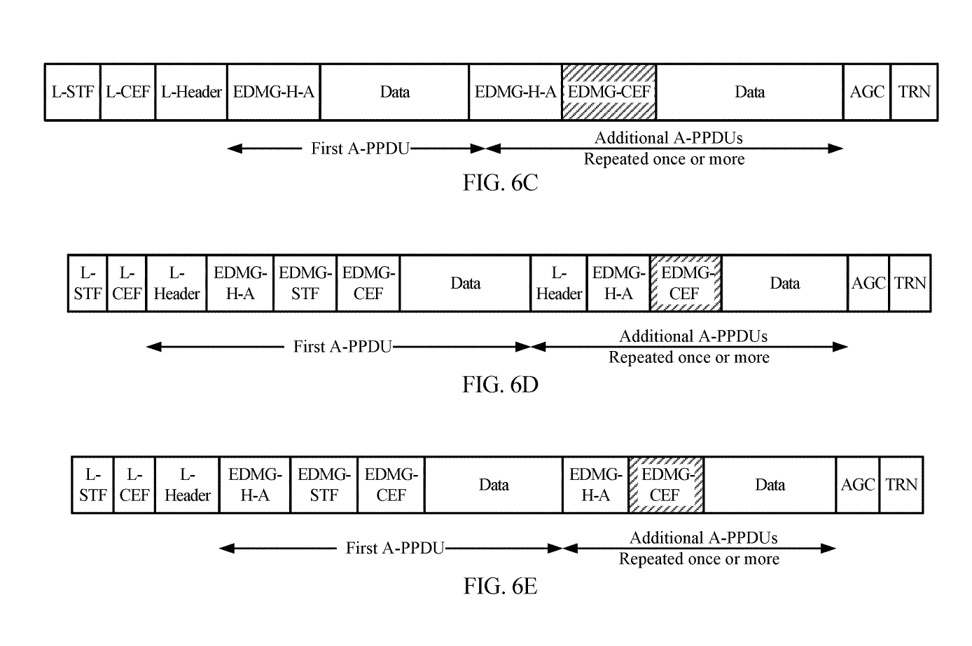

FIGS. 6-6I illustrate example frame formats having additional channel estimation fields, in accordance with certain aspects of the present disclosure. As shown in FIGS. 6 and 6A, the frame format of FIG. 4 may be modified to include an additional L-CEF before the data portion of each A-PPDU. As shown in FIG. 6A, the additional L-CEF could replace an L-Header and come after EDMG-H-A.

As shown in FIGS. 6B-6D, in some cases, the additional CEF could be EDMG-CEF. In some aspects, the L-Header may be resent (FIGS. 6, 6B, 6D, 6F, and 6H) or not resent (as in FIGS. 6A, 6C, 6E, 6G, and 6I) in the A-PPDUs other than the start of the frame. As illustrated, the additional CEF may be included in the A-PPDUs after the EDMG-H-A. In some aspects, the additional CEF may be included before the data portion in the A-PPDUs. In some aspects, the additional CEF may be included between a Header-A and Header-B in the A-PPDUs.

### Example Periodic CEF

According to certain aspects, a wireless node may insert a channel estimation field (e.g., EDMG-CEF) into the frame periodically (e.g., occurring every N data symbols). The periodicity of the CEF can be advertised in a header (e.g., in EDMG-Header-A). Transmission length of the L-Header may include the additional CEF that will be inserted.

When Aggregated PPDU (A-PPDU) transmission is used then the place to add the additional CEF will be according to payload symbols only, skipping the headers. Note that non-first L-Headers in A-PPDUs need to correctly be adjusted according to the additional CEFs.

According to the periodicity N of the CEFs, can be a function of an integer K [0 . . . Kₘₐₓ]. The function may be as follows:

N=2̂(K+4); or

N=table(K),

or another function may be used. Thus, the wireless node may indicate the integer in the header to the receiver and the receiver can use the integer compute the periodicity based on the function. In some cases, the transmitting device may delay occurrence of one of the channel estimation fields if the periodicity causes that channel estimation field to coincide with a non-data symbol.

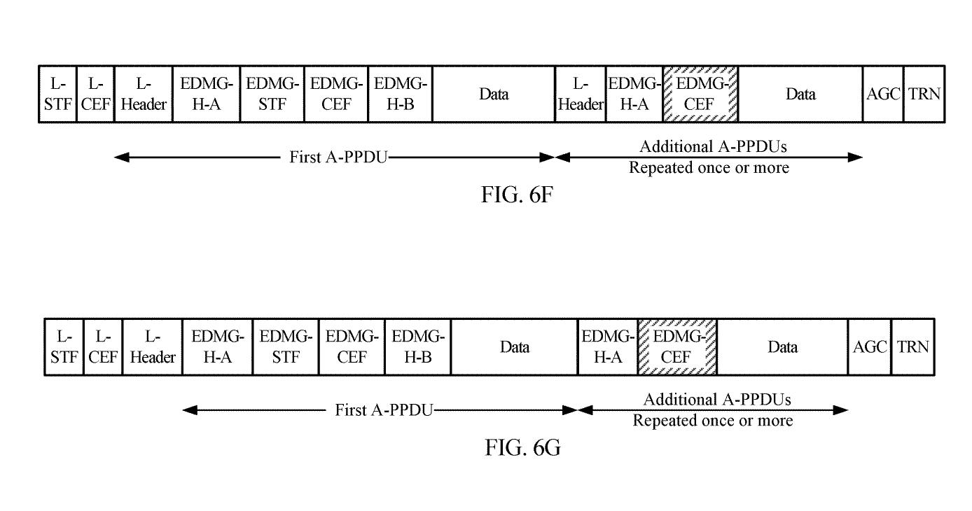

FIGS. 7-7C illustrate example frame formats having periodic channel estimation fields, in accordance with certain aspects of the present disclosure. As shown in FIGS. 7-7C, any of the frame formats illustrated in FIGS. 4-4B can be modified to include periodic channel estimation fields. In some aspects, the periodically repeated channel estimation fields may be L-CEF or EDMG-CEF. For example, FIG. 7 shows an example with periodically repeated L-CEF, while FIGS. 7A-7C show examples with periodically repeated EDMG-CEF.

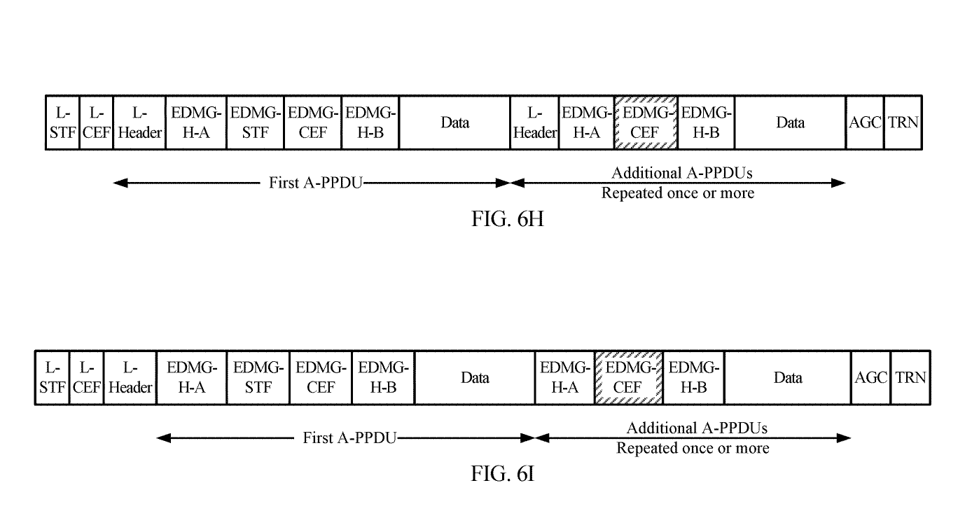

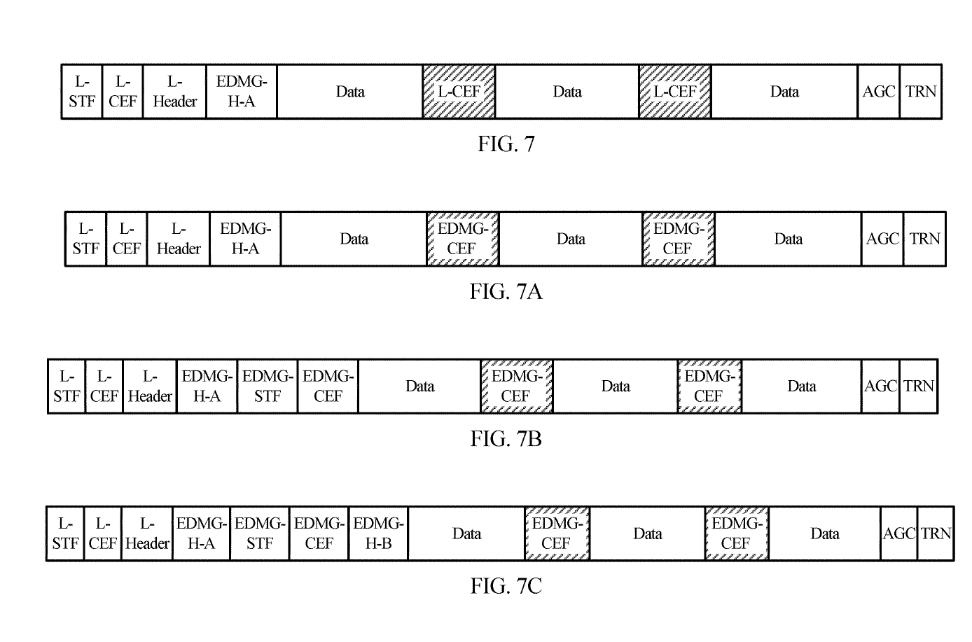

FIG. 8 sets forth example operations 800 for wireless communications, in accordance with certain aspects of the present disclosure. The operations 800 may be performed by an apparatus, for example, a station (e.g., STA 120). According to certain aspects, the operations 800 may be considered receiver-side operations corresponding the transmitter operations 500.

Operations 800 may begin at 802, by generating a first frame providing (e.g., in a capability element) an indication of a coherence time associated with the apparatus. At 804, the STA outputs the first frame for transmission to a wireless node. At 806, the STA obtain, from the wireless node, a second frame. At 808, the STA processes the second frame based at least in part on the coherence time indicated in the first frame.

### Example Scattered Pilots

According to certain aspects, scattered pilots can be used to support mobility. For high speed mobility, this may enable channel estimation to be performed frequently.

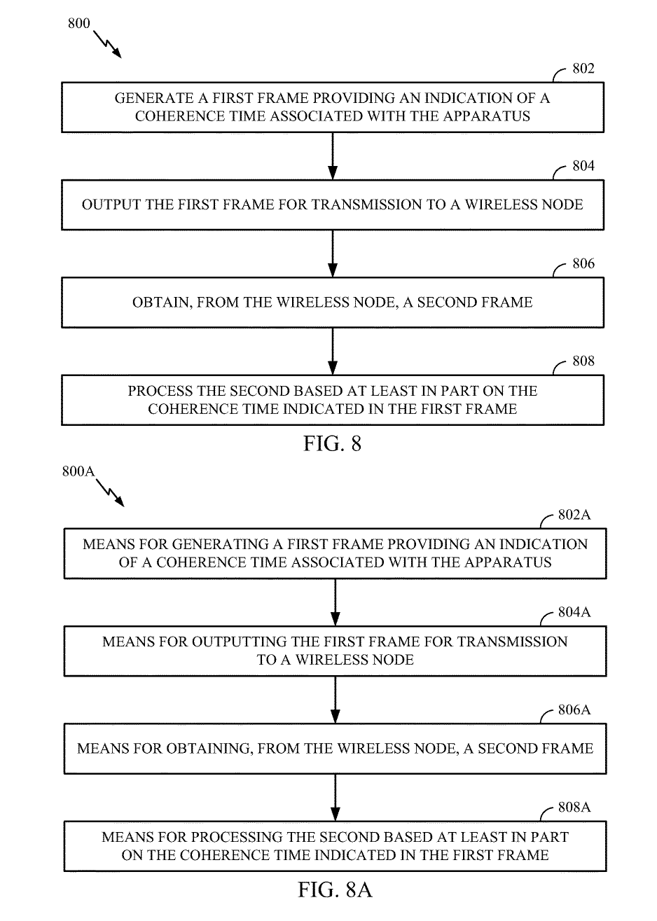

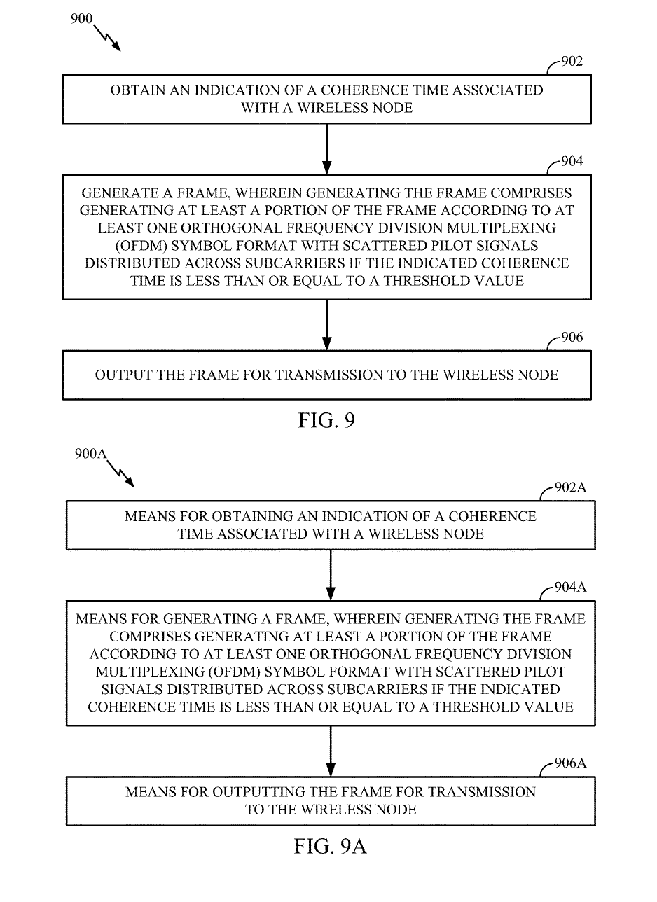

FIG. 9 sets forth example operations 900 for wireless communications, in accordance with certain aspects of the present disclosure. The operations 900 may be performed by a wireless node, for example, a station (e.g., AP 110 or STA 120).

Operations 900 may begin at 902, by obtaining an indication of a coherence time associated with a wireless node. At 904, the AP generates a frame, wherein generating the frame comprises generating at least a portion of the frame according to at least one OFDM symbol format with scattered pilot signals distributed across subcarriers if the indicated coherence time is less than or equal to a threshold value. At 906, the AP outputs the frame for transmission to the wireless node.

According to certain aspects, the AP generates the portion of the frame having one or more channel estimation fields in the portion of the frame, instead of according to the at least OFDM symbol format with scattered pilot signals, if the indicated coherence time is greater than the threshold value.

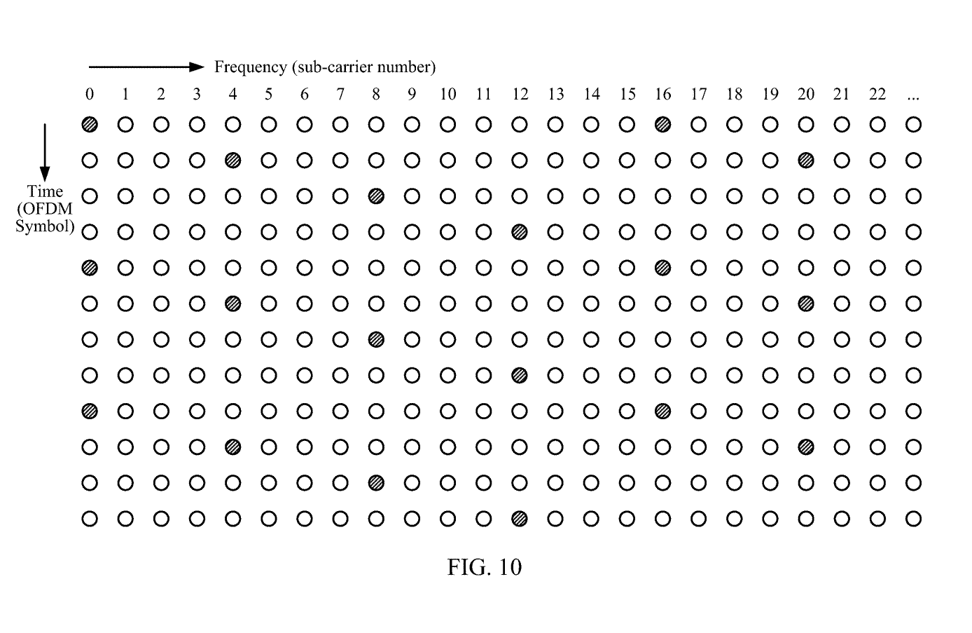

According to certain aspects, the data/payload OFDM symbols format (e.g., OFDM symbols mapping) may be changed to a format that uses scattered pilots (e.g., pilot signals). In one example implementation shown in FIG. 10, pilots can be spaced every 16 subcarriers and shifted by 4 subchannels each OFDM symbol. In aspects, other scattering patterns may be used. According to certain aspects, the scattering pattern used can be switched (e.g., a transmitting device may select one of the scattering patterns and signal some indication to allow the receiving device to identify the selected pattern).

According to certain aspects, the scattering pattern used can be based on coherence time. The frame may still include the EDMG-CEF. According to certain aspects, the scattered pilots can be transmitted at an elevated power level (relative to a transmit power used for other signals associated with the frame).

The use of scattered pilots can be signaled in a header (e.g., the EDMG-H-A) by a dedicated bit in the header. Each device may publish its capability to communicate (transmit or receive) using scattered pilots (e.g., in an information element).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500, 800, and 900 illustrated in FIGS. 5, 8, and 9, respectively, correspond to means 500A, 800A, and 900A illustrated in FIGS. 5A, 8A, and 9A, respectively.

FIG. 5A illustrates exemplary means 500A capable of performing the operations set forth in FIG. 5. The exemplary means 500A includes means 502A for obtaining an indication of a coherence time associated with a wireless node. Means 502A may include, for example, controller 280, RX data processor 270, RX spatial processor 260, receiver 254, and/or antenna 252 of the station (STA) 120 shown in FIG. 2; controller 230, RX data processor 242, RX spatial processor 240, receiver 222, and/or antenna 224 of the access point 110 shown in FIG. 2; and/or receiver 312, transceiver 314, signal detector 318, digital signal processor 320, and/or processor 304 of the wireless device shown in FIG. 3. Exemplary means 500A also includes means 504A for generating a first frame having a length being limited based at least in part on the indicated coherence time. Means 504A may include, for example, controller 230, TX data processor 210, TX spatial processor 220, and/or scheduler 234 of the access point 110 shown in FIG. 2; controller 280, TX data processor 288, and/or TX spatial processor 290 of the STA 120 shown in FIG. 2; and/or processor 304, and/or bus system 322 shown in FIG. 3. The exemplary means 500A includes means 506A for outputting the first frame for transmission to the wireless device. Means 506A may include, for example, controller 280, TX data processor 288, TX spatial processor 290, transmitter 254, and/or antenna 252 of the STA 120 shown in FIG. 2; controller 230, TX data processor 210, TX spatial processor 220, transmitter 222, and/or antenna 224 of the access point 110 shown in FIG. 2; and/or transmitter 310, transceiver 314, digital signal processor 320, and/or processor 304 of the wireless device shown in FIG. 3.

FIG. 8A illustrates exemplary means 800A capable of performing the operations set forth in FIG. 10. The exemplary means 800A includes means 802A for generating a first frame providing an indication of a coherence time associated with the apparatus. Means 802A may include, for example, controller 230, TX data processor 210, TX spatial processor 220, and/or scheduler 234 of the access point 110 shown in FIG. 2; controller 280, TX data processor 288, and/or TX spatial processor 290 of the STA 120 shown in FIG. 2; and/or processor 304, and/or bus system 322 shown in FIG. 3. The exemplary means 800A also includes means 804A for outputting the first frame for transmission to a wireless node. Means 804A may include, for example, controller 280, TX data processor 288, TX spatial processor 290, transmitter 254, and/or antenna 252 of the STA 120 shown in FIG. 2; controller 230, TX data processor 210, TX spatial processor 220, transmitter 222, and/or antenna 224 of the access point 110 shown in FIG. 2; and/or transmitter 310, transceiver 314, digital signal processor 320, and/or processor 304 of the wireless device shown in FIG. 3. The exemplary means 800A includes means 806A for obtaining, from the wireless node, a second frame. Means 806A may include, for example, controller 280, RX data processor 270, RX spatial processor 260, receiver 254, and/or antenna 252 of the station (STA) 120 shown in FIG. 2; controller 230, RX data processor 242, RX spatial processor 240, receiver 222, and/or antenna 224 of the access point 110 shown in FIG. 2; and/or receiver 312, transceiver 314, signal detector 318, digital signal processor 320, and/or processor 304 of the wireless device shown in FIG. 3. Exemplary means 800A also includes means 808A for processing the second frame based at least in part on the coherence time indicated in the first frame. 808A may include, for example, controller 230, TX data processor 210, TX spatial processor 220, and/or scheduler 234 of the access point 110 shown in FIG. 2; controller 280, TX data processor 288, and/or TX spatial processor 290 of the STA 120 shown in FIG. 2; and/or processor 304, and/or bus system 322 shown in FIG. 3.

FIG. 9A illustrates exemplary means 900A capable of performing the operations set forth in FIG. 9. The exemplary means 900A includes means 902A for obtaining an indication of a coherence time associated with a wireless node. Means 902A may include, for example, controller 280, RX data processor 270, RX spatial processor 260, receiver 254, and/or antenna 252 of the STA 120 shown in FIG. 2; controller 230, RX data processor 242, RX spatial processor 240, receiver 222, and/or antenna 224 of the access point 110 shown in FIG. 2; and/or receiver 312, transceiver 314, signal detector 318, digital signal processor 320, and/or processor 304 of the wireless device shown in FIG. 3. Exemplary means 900A also includes means 904A for generating a frame, wherein the processing system is configured to generate at least a portion of the frame according to at least one OFDM symbol format with scattered pilot signals distributed across subcarriers if the indicated coherence time is less than or equal to a threshold value. Means 904A may include, for example, controller 230, TX data processor 210, TX spatial processor 220, and/or scheduler 234 of the access point 110 shown in FIG. 2; controller 280, TX data processor 288, and/or TX spatial processor 290 of the STA 120 shown in FIG. 2; and/or processor 304, and/or bus system 322 shown in FIG. 3. The exemplary means 900A includes means 906A for outputting the frame for transmission to the wireless node. Means 906A may include, for example, controller 280, TX data processor 288, TX spatial processor 290, transmitter 254, and/or antenna 252 of the STA 120 shown in FIG. 2; controller 230, TX data processor 210, TX spatial processor 220, transmitter 222, and/or antenna 224 of the access point 110 shown in FIG. 2; and/or transmitter 310, transceiver 314, digital signal processor 320, and/or processor 304 of the wireless device shown in FIG. 3.

In addition, other means may include means for obtaining which may include, for example, controller 280, RX data processor 270, RX spatial processor 260, receiver 254, and/or antenna 252 of the STA 120 shown in FIG. 2; controller 230, RX data processor 242, RX spatial processor 240, receiver 222, and/or antenna 224 of the access point 110 shown in FIG. 2; and/or receiver 312, transceiver 314, signal detector 318, digital signal processor 320, and/or processor 304 of the wireless device shown in FIG. 3. Other means may include means for generating, means for determining, means for including, means for delaying, means for identifying, means for performing, and/or means for computing which may include, for example, controller 230, TX data processor 210, TX spatial processor 220, and/or scheduler 234 of the access point 110 shown in FIG. 2; controller 280, TX data processor 288, and/or TX spatial processor 290 of the STA 120 shown in FIG. 2; and/or processor 304, and/or bus system 322 shown in FIG. 3. Other means may include means for outputting and/or means for providing which may include, for example, controller 280, TX data processor 288, TX spatial processor 290, transmitter 254, and/or antenna 252 of the STA 120 shown in FIG. 2; controller 230, TX data processor 210, TX spatial processor 220, transmitter 222, and/or antenna 224 of the access point 110 shown in FIG. 2; and/or transmitter 310, transceiver 314, digital signal processor 320, and/or processor 304 of the wireless device shown in FIG. 3.

According to certain aspects, such means may be implemented by processing systems configured to perform the corresponding functions by implementing various algorithms (e.g., in hardware or by executing software instructions) described above for performing fast association. For example, means for identifying wakeup periods may be implemented by a processing system performing an algorithm that identifies wakeup periods based on a configuration (e.g., via an IE), means for determining whether to enable radio functions during wakeup periods may be implemented by a (same or different) processing system performing an algorithm that takes, as input, the wakeup periods and whether the presence of data has been indicated, while means for enabling radio functions may be implemented a (same or different) processing system performing an algorithm that takes, as input, the decision from means for determining and generates signals to enable/disable the radio functions accordingly.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a STA 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for obtaining at least a first frame with an indication of a time duration during which at least one bandwidth channel is occupied, instructions for tracking, based at least in part on the indicated duration, availability of time and one or more resources on a plurality of bandwidth channels including the at least one bandwidth channel, instructions for determining whether resources are available to transmit at least a second frame based on the tracked availability, instructions for outputting the second frame for transmission if the determination indicates resources are available.

Further, it should be appreciated that modules and/or other appropriate means for performing the methods and techniques described herein can be downloaded and/or otherwise obtained by a STA and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a STA and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a first interface configured to obtain an indication of a coherence time associated with a wireless node;
a processing system configured to generate a first frame having a length being limited based, at least in part, on the indicated coherence time; and
a second interface configured to output the first frame for transmission to the wireless node.

2. The apparatus of claim 1, wherein the first interface is configured to obtain the indication of the coherence time in a capability element obtained from the wireless node.

3. The apparatus of claim 1, wherein:
the processing system is further configured to determine a coherence time associated with the apparatus; and
the length of the first frame is based on a lesser of the indicated coherence time associated with the wireless node and the determined coherence time associated with the apparatus.

4. The apparatus of claim 1, wherein:
the first frame comprises a first aggregated physical layer convergence protocol (PLCP) data unit (A-PPDU) and at least one second A-PPDU, the first A-PPDU having a first header with a first channel estimation field; and
the processing system is configured to include, in each second A-PPDU, a second channel estimation field.

5. The apparatus of claim 4, wherein each second channel estimation field is the same as the first channel estimation field.

6. The apparatus of claim 4, wherein one or more of the second channel estimation fields are different than the first channel estimation field.

7. The apparatus of claim 4, wherein the processing system is further configured to provide, in each second A-PPDU, an indication of a presence of the second channel estimation field.

8. The apparatus of claim 1, wherein the processing system is configured to include at least two channel estimation fields in the first frame.

9. The apparatus of claim 8, wherein the at least two channel estimation fields occur in the first frame based on a periodicity.

10. The apparatus of claim 9, wherein:
the processing system is configured to delay occurrence of one of the at least two channel estimation fields if the periodicity causes that channel estimation field to coincide with a non-data symbol.

11. The apparatus of claim 9, wherein the processing system is configured to provide an indication, in the first frame, of the periodicity.

12. The apparatus of claim 11, wherein:
the periodicity is a function of an integer value; and
the indication of the periodicity comprises the integer value.

13. The apparatus of claim 8, wherein the at least two channel estimation fields comprise at least two different channel estimation fields.

14. The apparatus of claim 1, wherein:
at least a portion of the first frame has an orthogonal frequency division multiplexed (OFDM) symbol format with scattered pilot signals distributed across subcarriers.

15. An apparatus for wireless communications, comprising:
a processing system configured to generate a first frame providing an indication of a coherence time associated with the apparatus;
a first interface configured to output the first frame for transmission to a wireless node; and
a second interface configured to obtain, from the wireless node, a second frame, wherein the processing system is configured to process the second frame based at least in part on the coherence time indicated in the first frame.

16. The apparatus of claim 15, wherein the processing system is configured to provide the indication of the coherence time in a capability element in the first frame.

17. The apparatus of claim 15, wherein:
the second frame comprises a first channel estimation field and a second channel estimation field; and
the processing system is configured to identify a presence of the second channel estimation field based on an indication in the second frame.

18. The apparatus of claim 15, wherein:
the second frame comprises at least two channel estimation fields that occur in the second frame based on a periodicity; and
the processing system is configured to identify the periodicity based on an indication in the second frame.

19. The apparatus of claim 18, wherein:
the periodicity is a function of an integer value;
the indication comprises the integer value; and
the processing system is further configured to compute the periodicity based on the function and the integer value.

20. The apparatus of claim 15, wherein:
at least a portion of the second frame has an orthogonal frequency division multiplexed (OFDM) symbol format with scattered pilot signals distributed across subcarriers if the indicated coherence time is less than or equal to a threshold value; and
the processing system is further configured to perform channel estimation based on the scattered pilot signals.

21. An apparatus for wireless communications, comprising:
a processing system configured to generate a first frame providing an indication of a coherence time associated with the apparatus;
a first interface configured to output the first frame for transmission to a wireless node; and
a second interface configured to obtain, from the wireless node, a second frame having a length based on the indicated coherence time, wherein the processing system is configured to perform channel estimation based on scattered pilot signals distributed across subcarriers in a first portion of the second frame.

22. The apparatus of claim 21, wherein the processing system is configured to perform channel estimation based on the scattered pilot signals only if the indicated coherence time is greater than or equal to a threshold value.

23. The apparatus of claim 21, wherein:
a second portion of the second frame comprises a first channel estimation field and a second channel estimation field; and
the processing system is configured to identify a presence of the second channel estimation field based on an indication in the second frame.

24. A method for wireless communications by an apparatus, comprising:
obtaining an indication of a coherence time associated with a wireless node;
generating a first frame having a length being limited based at least in part on the indicated coherence time; and
outputting the first frame for transmission to the wireless node.

25. The method of claim 24, wherein the indication of the coherence time is obtained in a capability element obtained from the wireless node.

26. The method of claim 24, further comprising:
determining a coherence time associated with the apparatus; and
wherein the length of the first frame is based on a lesser of the indicated coherence time associated with the wireless node and the determined coherence time associated with the apparatus.

27. The method of claim 24, wherein:
the first frame comprises a first aggregated physical layer convergence protocol (PLCP) data unit (A-PPDU) and at least one second A-PPDU, the first A-PPDU having a first header with a first channel estimation field; and
the method comprises including, in each second A-PPDU, a second channel estimation field.

28. The method of claim 27, wherein each second channel estimation field is the same as the first channel estimation field.

29. The method of claim 27, wherein one or more of the second channel estimation fields are different than the first channel estimation field.

30. The method of claim 27, further comprising providing, in each second A-PPDU, an indication of a presence of the second channel estimation field.

31. The method of claim 24, further comprising including at least two channel estimation fields in the first frame.

32. The method of claim 31, wherein the at least two channel estimation fields occur in the first frame based on a periodicity.

33. The method of claim 32, further comprising:
delaying occurrence of one of the at least two channel estimation fields if the periodicity causes that channel estimation field to coincide with a non-data symbol.

34. The method of claim 32, further comprising providing an indication, in the first frame, of the periodicity.

35. The method of claim 34, wherein:
the periodicity is a function of an integer value; and
the indication of the periodicity comprises the integer value.

36. The method of claim 31, wherein the at least two channel estimation fields comprise at least two different channel estimation fields.

37. The method of claim 24, wherein:
at least a portion of the first frame has an orthogonal frequency division multiplexed (OFDM) symbol format with scattered pilot signals distributed across subcarriers.

38. A method for wireless communications by an apparatus, comprising:
generating a first frame providing an indication of a coherence time associated with the apparatus;
outputting the first frame for transmission to a wireless node;
obtaining, from the wireless node, a second frame; and
processing the second frame based at least in part on the coherence time indicated in the first frame.

39. The method of claim 38, further comprising providing the indication of the coherence time in a capability element in the first frame.

40. The method of claim 38, wherein:
the second frame comprises a first channel estimation field and a second channel estimation field; and
the method further comprises identifying a presence of the second channel estimation field based on an indication in the second frame.

41. The method of claim 38, wherein:
the second frame comprises at least two channel estimation fields that occur in the second frame based on a periodicity; and
the method further comprises identifying the periodicity based on an indication in the second frame.

42. The method of claim 41, wherein:
the periodicity is a function of an integer value;
the indication comprises the integer value; and
the method further comprises computing the periodicity based on the function and the integer value.

43. The method of claim 38, wherein:
at least a portion of the second frame has an orthogonal frequency division multiplexed (OFDM) symbol format with scattered pilot signals distributed across subcarriers if the indicated coherence time is less than or equal to a threshold value; and
the method further comprises performing channel estimation based on the scattered pilot signals.

44. A method for wireless communications, comprising:
generating a first frame providing an indication of a coherence time associated with the apparatus;
outputting the first frame for transmission to a wireless node; and
obtaining, from the wireless node, a second frame having a length based on the indicated coherence time; and
performing channel estimation based on scattered pilot signals distributed across subcarriers in a first portion of the second frame.

45. The method of claim 44, wherein the channel estimation based on the scattered pilot signals is performed only if the indicated coherence time is greater than or equal to a threshold value.

46. The method of claim 44, wherein:
a second portion of the second frame comprises a first channel estimation field and a second channel estimation field; and
the method further comprises identifying a presence of the second channel estimation field based on an indication in the second frame.

47. An apparatus for wireless communications, comprising:
means for obtaining an indication of a coherence time associated with a wireless node;
means for generating a first frame having a length being limited based at least in part on the indicated coherence time; and
means for outputting the first frame for transmission to the wireless node.

48. The apparatus of claim 47, wherein the means for obtaining is configured to obtain the indication of the coherence time in a capability element obtained from the wireless node.

49. The apparatus of claim 47, further comprising:
means for determining a coherence time associated with the apparatus; and
wherein the length of the first frame is based on a lesser of the indicated coherence time associated with the wireless node and the determined coherence time associated with the apparatus.

50. The apparatus of claim 47, wherein:
the first frame comprises a first aggregated physical layer convergence protocol (PLCP) data unit (A-PPDU) and at least one second A-PPDU, the first A-PPDU having a first header with a first channel estimation field; and
the apparatus comprises means for including, in each second A-PPDU, a second channel estimation field.

51. The apparatus of claim 50, wherein each second channel estimation field is the same as the first channel estimation field.

52. The apparatus of claim 50, wherein one or more of the second channel estimation fields are different than the first channel estimation field.

53. The apparatus of claim 50, further comprising means for providing, in each second A-PPDU, an indication of a presence of the second channel estimation field.

54. The apparatus of claim 47, further comprising means for including at least two channel estimation fields in the first frame.

55. The apparatus of claim 54, wherein the at least two channel estimation fields occur in the first frame based on a periodicity.

56. The apparatus of claim 55, further comprising:
means for delaying occurrence of one of the at least two channel estimation fields if the periodicity causes that channel estimation field to coincide with a non-data symbol.

57. The apparatus of claim 55, further comprising means for providing an indication, in the first frame, of the periodicity.

58. The apparatus of claim 57, wherein:
the periodicity is a function of an integer value; and
the indication of the periodicity comprises the integer value.

59. The apparatus of claim 54, wherein the at least two channel estimation fields comprise at least two different channel estimation fields.

60. The apparatus of claim 47, wherein:
at least a portion of the first frame has an orthogonal frequency division multiplexed (OFDM) symbol format with scattered pilot signals distributed across subcarriers.

61. An apparatus for wireless communications, comprising:
means for generating a first frame providing an indication of a coherence time associated with the apparatus;
means for outputting the first frame for transmission to a wireless node; and
means for obtaining, from the wireless node, a second frame; and
means for processing the second frame based at least in part on the coherence time indicated in the first frame.

62. The apparatus of claim 61, further comprising means for providing the indication of the coherence time in a capability element in the first frame.

63. The apparatus of claim 61, wherein:
the second frame comprises a first channel estimation field and a second channel estimation field; and
the apparatus further comprises means for identifying a presence of the second channel estimation field based on an indication in the second frame.

64. The apparatus of claim 61, wherein:
the second frame comprises at least two channel estimation fields that occur in the second frame based on a periodicity; and
the apparatus comprises means for identifying the periodicity based on an indication in the second frame.

65. The apparatus of claim 64, wherein:
the periodicity is a function of an integer value;
the indication comprises the integer value; and
the apparatus comprises means for computing the periodicity based on the function and the integer value.

66. The apparatus of claim 61, wherein:
at least a portion of the second frame has an orthogonal frequency division multiplexed (OFDM) symbol format with scattered pilot signals distributed across subcarriers if the indicated coherence time is less than or equal to a threshold value; and
the apparatus comprises means for performing channel estimation based on the scattered pilot signals.

67. An apparatus for wireless communications, comprising:
means for generating a first frame providing an indication of a coherence time associated with the apparatus;
means for outputting the first frame for transmission to a wireless node; and
means for obtaining, from the wireless node, a second frame having a length based on the indicated coherence time; and
means for performing channel estimation based on scattered pilot signals distributed across subcarriers in a first portion of the second frame.

68. The apparatus of claim 67, wherein the channel estimation is performed based on the scattered pilot signals only if the indicated coherence time is greater than or equal to a threshold value.

69. The apparatus of claim 67, wherein:
a second portion of the second frame comprises a first channel estimation field and a second channel estimation field; and
the apparatus comprises means for identifying a presence of the second channel estimation field based on an indication in the second frame.

70. A wireless node, comprising:
a receiver configured to receive an indication of a coherence time associated with an apparatus;
a processing system configured to generate a first frame having a length being limited based at least in part on the indicated coherence time; and
a transmitter configured to transmit the first frame for transmission to the apparatus.

71. A wireless node, comprising:
a processing system configured to generate a first frame providing an indication of a coherence time associated with the wireless node;
a transmitter configured to transmit the first frame for transmission to an apparatus; and
a receiver configured to receive, from the apparatus, a second frame, wherein the processing system is configured to process the second frame based at least in part on the coherence time indicated in the first frame.

72. A wireless node, comprising:
a processing system configured to generate a first frame providing an indication of a coherence time associated with the apparatus;
a transmitter configured to transmit the first frame to a wireless node; and
a receiver configured to receive, from the wireless node, a second frame having a length based on the indicated coherence time, wherein the processing system is configured to perform channel estimation based on scattered pilot signals distributed across subcarriers in a first portion of the second frame.

73. A computer readable medium having instructions stored thereon for:
obtaining an indication of a coherence time associated with a wireless node;
generating a first frame having a length being limited based at least in part on the indicated coherence time; and
outputting the first frame for transmission to the wireless node.

74. A computer readable medium having instructions stored thereon for:
generating a first frame providing an indication of a coherence time associated with the apparatus;
outputting the first frame for transmission to a wireless node;
obtaining, from the wireless node, a second frame; and
processing the second frame based at least in part on the coherence time indicated in the first frame.

75. A computer readable medium having instructions stored thereon for:
generating a first frame providing an indication of a coherence time associated with the apparatus;
outputting the first frame for transmission to a wireless node; and
obtaining, from the wireless node, a second frame having a length based on the indicated coherence time; and
performing channel estimation based on scattered pilot signals distributed across subcarriers in a first portion of the second frame.
